(19) United States
(12) Patent Application Publication
(10) Pub. No.: US 2010/0201490 A1
(43) Pub. Date: Aug. 12, 2010

(54) DISPLAY DEVICE AND DISPLAY SYSTEM THEREOF

(76) Inventors: Chun-Hui Huang, Hsinchu (TW); Cheng-Chung Lin, Hsinchu (TW); Kuo-Yuan Tseng, Hsinchu (TW)

Correspondence Address: Muncy, Geissler, Olds & Lowe, PLLC, 4000 Legato Road, Suite 310, FAIRFAX, VA, 22033, US

(21) Appl. No.: 12/404,850

(22) Filed: Mar. 16, 2009

(30) Foreign Application Priority Data
Feb. 6, 2009 (TW) 98103835

(51) Int. Cl. H04B 7/00

(52) U.S. Cl. 340/10.1

(57) ABSTRACT

A display device includes a RFID tag unit, a display unit, a processing unit and a power supply unit. The RFID tag unit follows a wireless communication standard of a RFID system to receive a wireless signal and outputs identification information. The processing unit electrically connected with the RFID tag unit and the display unit receives the identification information and outputs to the display unit for displaying. The power supply unit supplies operation power required to the processing unit and the display unit. The required power while the above-mentioned display device refreshes the information is supplied by the power supply unit, so that the information can be refreshed with longer communication distance and power saving is achieved. A display system including the above-mentioned display device and a reader/writer device is also disclosed.

### BACKGROUND OF THE INVENTION

1. Field of the Invention

The present invention relates to a display device and display system thereof, and more particularly to a display device with a wireless communication module and lower power consumption and display system thereof.

2. Description of the Prior Art

Slim and flat-panel display is utilized extensively at exhibition space for providing useful information because of the small volume. The information providing display is mostly arranged separately at various specific locations, therefore, it is unrealistic that refreshing display information of display by wire connection. Accordingly, it is a better acceptable solution for user by utilizing wireless connection to refresh display information of display.

Wireless communication techniques including: Infrared (IR) transmission, wireless local area network, Bluetooth, Zigbee and Radio Frequency Identification (RFID) etc. However, the directivity of IR transmission is worse and prone to be shielded to affect the communication quality. The power consumption and cost of wireless local area network, Bluetooth and Zigbee are high. Although RFID system is bidirectional communication, a better communication quality is required to supply a stable and sufficient power when the data is written into an Electrically Erasable Programmable Read-Only Memory (EEPROM) inside a Tag. It is still unrealistic that the communication distance is only 1 meter. Additionally, EEPROM inside Tag is able to be written about 100 thousand times, which is not suitable for the application of frequent information refreshing.

To sum up, how to provide a cost-effective method to integrate wireless communication techniques with display to wirelessly refresh the display information and save more power is a current goal to be achieved.

### SUMMARY OF THE INVENTION

The present invention is directed to a display device and display system thereof which includes a RFID tag to be a wireless communication module and a power supply unit to supply required power for refreshing information. Accordingly, the display device and display system thereof of the present invention may be able to refresh information with longer communication distance and more power saving than other wireless communication techniques.

In one embodiment, the proposed display device includes a RFID tag unit, a display unit, a processing unit and a power supply unit. The RFID tag unit follows a wireless communication standard of a RFID system to receive a wireless signal and outputs identification information. The identification information is displayed by the display unit. The processing unit electrically connected with the RFID tag unit and the display unit receives the identification information and outputs to the display unit for displaying. The power supply unit supplies operation power required to the processing unit and the display unit.

In another embodiment, the proposed display system includes a reader/writer device and a display device. The reader/writer device follows a wireless communication standard of a RFID system to transmit and/or receive a wireless signal. The display device includes a RFID tag unit, a display unit, a processing unit and a power supply unit. The RFID tag unit follows the wireless communication standard of the RFID system to receive the wireless signal and outputs identification information. The identification information is displayed by the display unit. The processing unit electrically connected with the RFID tag unit and the display unit receives the identification information and outputs to the display unit for displaying. The power supply unit supplies operation power required to the processing unit and the display unit.

The objective, technologies, features and advantages of the present invention will become apparent from the following description in conjunction with the accompanying drawings wherein are set forth, by way of illustration and example, certain embodiments of the present invention.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 is block diagram schematically illustrating a display device and a display system thereof in accordance with an embodiment of the present invention;

FIG. 2 is block diagram schematically illustrating a display device in accordance with another embodiment of the present invention.

### DESCRIPTION OF THE PREFERRED EMBODIMENT

The detailed explanation of the present invention is described as following. The described preferred embodiments are presented for purposes of illustrations and description, and they are not intended to limit the scope of the present invention.

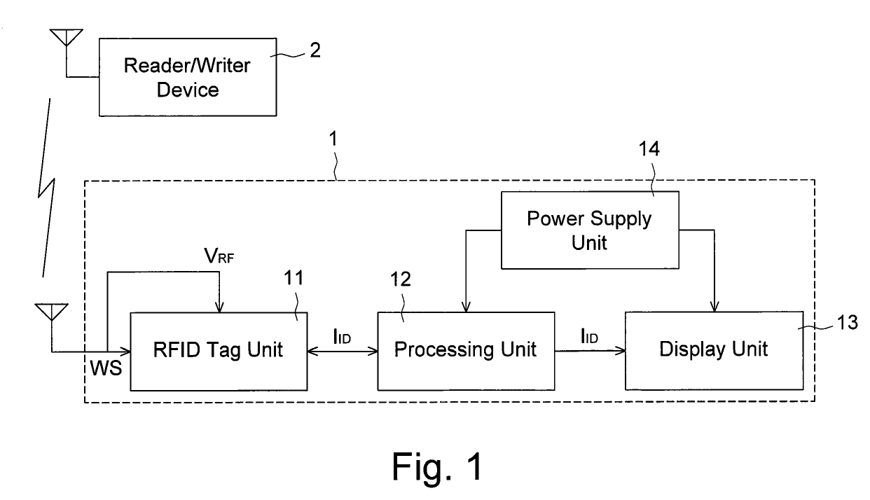

Referring to FIG. 1, in accordance with an embodiment of the present invention, the display system comprises a display device 1 and a reader/writer device 2. The reader/writer device 2 follows a wireless communication standard of a radio frequency identification (RFID) system to transmit a wireless signal WS, which comprises an identification information I_{ID}. The display device 1 comprises a radio frequency identification tag (RFID tag) unit 11, a processing unit 12, a display unit 13 and a power supply unit 14. The RFID tag unit 11 follows the wireless communication standard of the RFID system to receive the wireless signal WS transmitted by the reader/writer device 2 and outputs the identification information I_{ID}. In one embodiment, a communication frequency of RFID system may be under 135 KHz, 13.56 MHz, 860 MHz-960 MHz (UHF bandwidth), 2.45 GHz or 5.8 GHz.

The identification information I_{ID} is displayed by the display unit 13. The processing unit 12 is electrically connected with the RFID tag unit 11 and the display unit 13 for receiving the identification information I_{ID} and outputting the identification information I_{ID} to the display unit 13 for displaying. The power supply unit 14 supplies operation power required to the processing unit 12 and the display unit 13. In one embodiment, the power supply unit 14 may be a battery module and/or an external power. For example, the battery module may be a rechargeable battery or a disposable battery. In accordance with the standard of the RFID system, the RFID tag unit 11 extracts a radio frequency power V_{RF} from the wireless signal WS as the operation power required to the RFID tag unit 11. Accordingly, the RFID tag unit 11 may not consume additional power while the display device of the present invention is in standby condition.

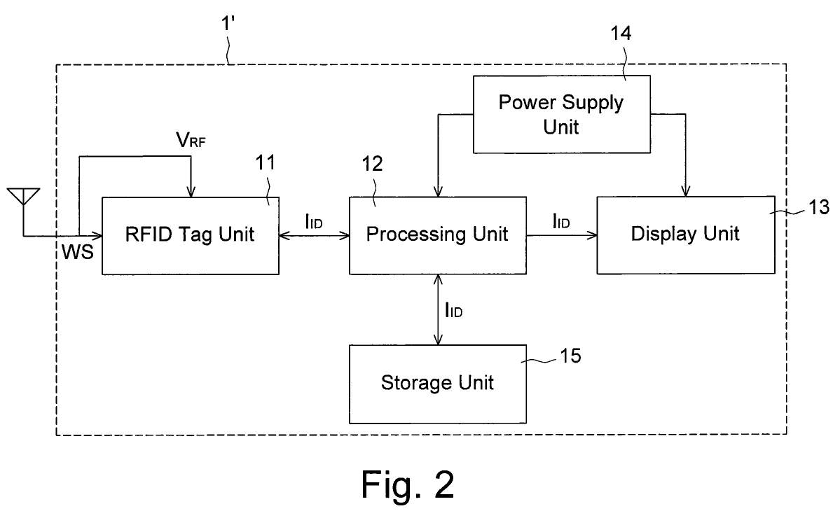

Referring to FIG. 2, the display device 1′ of another embodiment of the present invention comprises a storage unit 15. The storage unit 15 is electrically connected with the processing unit 12 to store the identification information I_{ID}. For example, the storage unit 15 may be a memory or a hard drive. The processing unit 12 may read the identification information I_{ID} from the storage unit 15 and processes the identification information I_{ID} into the wireless signal WS with RFID format. And then the wireless signal WS is transmitted by the RFID tag unit 11 to the reader/writer device 2 (as shown in FIG. 1), so that bidirectional communication between the reader/writer device 2 and the display device 1′ may be achieved. In another word, the reader/writer device 2 may write the identification information I_{ID} into the display device 1′ and may read the identification information I_{ID} from the display device 1′.

In accordance with the aforesaid structure, the RFID tag unit 11 may eliminate a built-in Electrically Erasable Programmable Read-Only Memory (EEPROM). The RFID tag unit 11 directly outputs the identification information I_{ID} extracted from the wireless signal WS to the processing unit 12, without writing into the EEPROM built in the RFID tag unit 11. The operation power that the display device requires to access the storage unit (memory or hard drive for example) is supplied by the power supply unit 14, therefore, the reader/writer device 2 may write the identification information I_{ID} into the display device 1 with longer communication distance.

In one embodiment, the display unit 13 may be a Bi-Stable Display. For example, the display unit 13 may be a Cholesterol LCD, a Ferroelectric LCD, an Electrophoresis LCD, a MEMs switchable reflector display or an Electrochromic films display. The power is consumed only when the Bi-Stable Display needs to be refreshed, therefore, the power consumed by the display device 1 is extremely less, even the power consumption is zero. That is, the power saving is achieved. It should be noted that the display unit 13 is not limited to Bi-Stable Display. For example, an external power or self-electricity generating power such as solar power is utilized in display device 1, the display unit 13 may also be a more power consumption display, such as conventional LCD or an Organic Light Emitting Diodes (OLED) etc.

Additionally, depending on the application, the size of the display unit 13 may be free designed. For example, the display device 1 with smaller-sized display unit 13 may be used as a Electronic Label for showing price, manufacture date, the place of production and any information related to the products; the display device 1 with bigger-sized display unit 13 may be used as a digital photo frame; the display device 1 with much bigger-sized display unit 13 may be used as electronic bulletin.

To summarize the foregoing descriptions, the display device and display system thereof of the present invention, which includes a RFID tag to be a wireless communication module and a power supply unit to supply required power for refreshing information. Therefore, the display device and display system thereof of the present invention may be able to refresh information with longer communication distance and more power saving than other wireless communication techniques. Additionally, utilizing the power saving Bi-Stable Display as display unit may further improve the effect of power saving. Furthermore, the display device and display system thereof of the present invention includes the storage unit able to be written more times such as a memory or hard drive instead of the EEPROM built in the RFID Tag unit so as to avoid being limited by the EEPROM which can only be written about 100,000 times.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A display device comprising:
a RFID tag unit, following a wireless communication standard of a RFID system to receive a wireless signal and outputs identification information;
a display unit, displaying said identification information;
a processing unit, electrically connected with said RFID tag unit and said display unit for receiving said identification information and outputting to said display unit for displaying; and
a power supply unit, supplying operation power required to said processing unit and said display unit.

2. The display device of claim 1, further comprising a storage unit, electrically connected with said processing unit for storing said identification information.

3. The display device of claim 2, wherein said processing unit reads said identification information from said storage unit and processes into said wireless signal, said wireless signal is transmitted by said RFID tag unit.

4. The display device of claim 2, wherein said storage unit comprises a memory or a hard drive.

5. The display device of claim 1, wherein communication frequency of said RFID system comprises under 135 KHz, 13.56 MHz, 860 MHz-960 MHz, 2.45 GHz or 5.8 GHz.

6. The display device of claim 1, wherein said display unit comprises a LCD or an OLED.

7. The display device of claim 1, wherein said display unit comprises a Bi-Stable Display.

8. The display device of claim 1, wherein said display unit comprises a Cholesterol LCD, a Ferroelectric LCD, an Electrophoresis LCD, a MEMs switchable reflector display or an Electrochromic films display.

9. The display device of claim 1, wherein said power supply unit comprises a battery module and/or an external power.

10. The display device of claim 1, wherein said power supply unit comprises a rechargeable battery or a disposable battery.

11. A display system comprising:
a reader/writer device following a wireless communication standard of a RFID system to transmit and/or receive a wireless signal; and
a display device comprising:
a RFID tag unit, following said wireless communication standard of said RFID system to receive said wireless signal and outputs identification information;
a display unit, displaying said identification information;
a processing unit, electrically connected with said RFID tag unit and said display unit for receiving said identification information and outputting to said display unit for displaying; and
a power supply unit, supplying operation power required to said processing unit and said display unit.

12. A display system of claim 11, further comprising a storage unit, electrically connected with said processing unit for storing said identification information.

13. A display system of claim 12, wherein said processing unit reads said identification information from said storage unit and processes into said wireless signal, said wireless signal is transmitted by said RFID tag unit.

14. The display system of claim 12, wherein said storage unit comprises a memory or a hard drive.

15. The display system of claim 11, wherein communication frequency of said RFID system comprises under 135 KHz, 13.56 MHz, 860 MHz-960 MHz, 2.45 GHz or 5.8 GHz.

16. The display system of claim 11, wherein said display unit comprises a LCD or an OLED.

17. The display system of claim 11, wherein said display unit comprises a Bi-Stable Display.

18. The display system of claim 11, wherein said display unit comprises a Cholesterol LCD, a Ferroelectric LCD, an Electrophoresis LCD, a MEMs switchable reflector display or an Electrochromic films display.

19. The display system of claim 11, wherein said power supply unit comprises a battery module and/or an external power.

20. The display system of claim 11, wherein said power supply unit comprises a rechargeable battery or a disposable battery.
